(19) United States
(12) Patent Application Publication
(10) Pub. No.: US 2005/0036258 A1
(43) Pub. Date: Feb. 17, 2005

(54) Power strips with embedded controllers

(76) Inventors: Xlu Juan Ma, Troy, MI (US); Robert Jiajian Lin, Troy, MI (US)

Correspondence Address: Xiu Juan Ma, 346 Lvy Lane, Troy, MI, 48098, US

(21) Appl. No.: 10/637,858

(22) Filed: Aug. 11, 2003

(51) Int. Cl. H02H 5/04

(52) U.S. Cl. 361/103

(57) ABSTRACT

A power strip with an embedded temperature/timing controller includes a set of primary receptacles and a set of secondary receptacles. The primary receptacles are connected to a power source just like conventional power strips. The secondary receptacles are controlled by the temperature/timing controller to switch power on and off. In a heating control mode, the secondary receptacles are switched on if the room temperature is below the desired temperature. In a cooling control mode, the secondary receptacles are switched on if the room temperature is above the desired temperature. In a timing control mode, the secondary receptacles are switched on for certain periods of time.

### BACKGROUND OF INVENTION

Power strips are electrical products used widely in offices and homes. People use power strips to connect heaters, air-conditioners, TVs, computers, etc. Simple power strips provide power line extension and multiple outlets. More sophisticated power strips also provide surge protection and some other functions. There are many patents issued on the power strip: for example, U.S. Pat. No. 6,509,655, U.S. Pat. No. 6,486,407, U.S. Pat. No. D465,372, U.S. Pat. No. 6,454,609, U.S. Pat. No. 6,406,308, U.S. Pat. No. D445,401, U.S. Pat. No. D397,089. However none of these power strips have temperature/timing controllers embedded in them. Temperature/timing-controlled power strips can be used to connect heaters, air-conditioners and other appliances. They provide precision temperature/timing control and hence to save energy, to prevent the heater from overheating or to achieve other desired control actions.

### BRIEF DESCRIPTION OF DRAWINGS

FIG. 1 is an illustration of the preferred embodiment of the invention.

FIG. 2 is a diagram showing components and connections of the temperature/timing controller.

### DETAILED DESCRIPTION

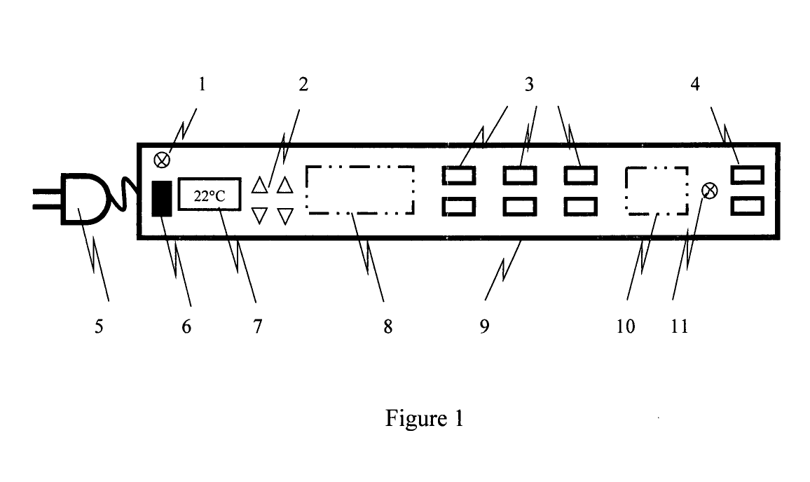

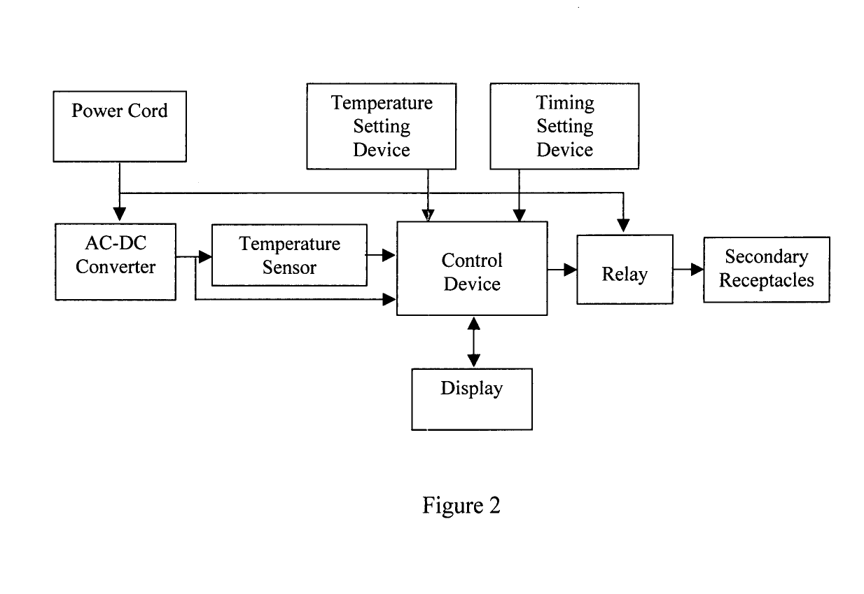

The invented temperature/timing-controlled power strip is illustrated in FIG. 1. In the figure, 5 is a power cord to be connected to a power outlet that supplies a high voltage AC power. The other components are contained within the housing 9. 6 is a power switch used to turn power supply on or off. Inside the housing and not shown in the figure, there is a surge protector to switch off the power supply during a power surge. 1 is a power on/off indicator that indicates whether the power switch is on or off. 2 is a temperature/timing setting device that allows a user to set a desired temperature or desired time period. Pressing one set of arrows sets the desired temperature and puts the controller in temperature control modes. Pressing another set of arrows sets the desire time period and put the controller in a timing control mode. Inside the housing and not shown in the figure, there is a temperature sensor that measures the surrounding room temperature. 7 is an LCD or LED display that displays the desired temperature/time period during setting up. For the rest of time, its displays the room temperature if it is in the temperature control modes and displays the time periods if it is in the timing control modes. A temperature/timing controller 8 to be discussed in details below is contained inside the housing. 3 is a set of primary receptacles that are connected to a power source via switch 6 as in conventional power strips. 4 is a set of secondary receptacles that are controlled by the temperature/timing controller to switch the power on and off. The switching is achieved by a relay 10 contained inside the housing. An output on/off indicator 11 indicates whether power supply to the secondary receptacles is on or off. The temperature/timing controller is shown in the diagram of FIG. 2. The controller uses a low voltage DC power, which is supplied by an AC-DC Convert. There are several standard ways to do this conversion. In the temperature (heating or cooling) control modes, the surrounding room temperature is measured by a temperature sensor. Temperature sensors are commercially available. The output of the temperature sensor is sent to a control device. The control device can be implemented on an analog circuit or on a microcontroller, which is the preferred implementation. There are several microcontrollers that can be used to implement the control device. The control device also takes the desired temperature from the temperature setting device. It then compares the room temperature with the desired temperature to control the relay. The relay will then switches the power supply to the secondary receptacles on or off. In the heating control mode, the control device will control the relay to switch on the power supply to the secondary receptacles when the room temperature is below the desired temperature. In the cooling control mode, the control device will control the relay to switch on the power supply to the secondary receptacles when the room temperature is above the desired temperature. In the timing control mode, the control device takes the desired time periods from the timing setting device. The control device will control the relay to switch on the power supply to the secondary receptacles according to the desired timing setting.

1. A temperature-controlled power strip comprising:
a power cord to be connected to a power supply;
a set of primary receptacles for power output;
a set of secondary receptacles for controlled power output; and
a temperature controller that controls the power output of said secondary receptacles.

2. The power strip, as defined in claim 1, further comprising a housing, and wherein said primary receptacle, said secondary receptacles, and said temperature controller are disposed in said housing.

3. The power strip, as defined in claim 2, wherein said temperature controller comprises
a AC to DC converter that converts a high voltage AC power to a low voltage DC power;
a temperature sensor that measures the room temperature;
a temperature setting device that allows a user to set a desired temperature;
a display that displays said room temperature or said desired temperature;
a relay that switches said power supply to said secondary receptacles on or off; and
a control device that controls said relay according to said room temperature and said desired temperature.

4. The power strip, as defined in claim 3, wherein said control device operates in a heating control mode which controls said relay to switch on said power supply to said secondary receptacles if said room temperature is below said desired temperature.

5. The power strip, as defined in claim 3, wherein said control device operates in a cooling control mode which controls said relay to switch on said power supply to said secondary receptacles if said room temperature is above said desired temperature.

6. The power strip, as defined in claim 3, wherein said control device is implemented in a microcontroller.

7. The power strip, as defined in claim 3, wherein said control device is implemented by an analog circuit.

8. The power strip, as defined in claim 3, wherein said display is a LED display.

9. The power strip, as defined in claim 3, wherein said display is a LCD display.

10. The power strip, as defined in claim 3, wherein said relay is a mechanical relay.

11. The power strip, as defined in claim 3, wherein said relay is an electrical relay.

12. The power strip, as defined in claim 1 further comprising
a power switch to turn on or off said power supply;
a surge protector to switch off said power supply to said primary receptacle and said secondary receptacles during a power surge;
a power on/off indicator that indicates whether said power switch is on or off;
an output on/off indicator that indicates whether said power supply to said secondary receptacle is on or off.

13. A timing-controlled power strip comprising:
a power cord to be connected to a power supply;
a set of primary receptacles for power output;
a set of secondary receptacles for controlled power output; and
a timing controller that controls the power output of said secondary receptacles.

14. The power strip, as defined in claim 13 further comprising a housing, and wherein said primary receptacle, said secondary receptacles, and said timing controller are disposed in said housing.

15. The power strip, as defined in claim 14, wherein said timing controller comprises
a AC to DC converter that converts a high voltage AC power to a low voltage DC power;
a time period setting device that allows a user to set a desired time period;
a display that displays said desired time period;
a relay that switches said power supply to said secondary receptacles on or off; and
a control device that controls said relay according to said desired time period.

16. The power strip, as defined in claim 15, wherein said control device is implemented in a microcontroller.

17. The power strip, as defined in claim 15, wherein said control device is implemented by an analog circuit.

18. The power strip, as defined in claim 15, wherein said display is a LED display.

19. The power strip, as defined in claim 15, wherein said display is a LCD display.

20. The power strip, as defined in claim 15, wherein said relay is a mechanical relay.

21. The power strip, as defined in claim 15, wherein said relay is an electrical relay.

22. The power strip, as defined in claim 13 further comprising
a power switch to turn on or off said power supply;
a surge protector to switch off said power supply to said primary receptacle and said secondary receptacles during a power surge;
a power on/off indicator that indicates whether said power switch is on or off;
an output on/off indicator that indicates whether said power supply to said secondary receptacle is on or off.
